(19) United States
(12) Patent Application Publication
(10) Pub. No.: US 2020/0175892 A1
(43) Pub. Date: Jun. 4, 2020

(54) SIMULATED SEALANT AND TEST PIECE FOR SEALING OPERATION TRAINING

(71) Applicant: MITSUBISHI HEAVY INDUSTRIES, LTD., Tokyo (JP)

(72) Inventors: Keitaro SAKURAI, Tokyo (JP); Norihisa HORAGUCHI, Tokyo (JP)

(21) Appl. No.: 16/615,459

(22) PCT Filed: May 30, 2018
(86) PCT No.: PCT/JP2018/020741

§ 371 Date: Nov. 21, 2019

(30) Foreign Application Priority Data
Jun. 6, 2017 (JP) 2017-111341

(51) Int. Cl. G09B 23/24; C09K 3/10

(52) U.S. Cl. CPC G09B 23/24; C09K 3/1006

(57) ABSTRACT

A simulated sealant which comprises a polybutene resin and a polyethylene resin, wherein the polyethylene resin is in a sol state and is dispersed in the polybutene resin.

### TECHNICAL FIELD

The present invention relates to a simulated sealant and a test piece for sealing operation training.

Priority is claimed on Japanese Patent Application No. 2017-111341 filed on Jun. 6, 2017, the content of which is incorporated herein by reference.

### BACKGROUND ART

In the past, in various manufacturing sites, in order to improve a learning level in an application operation (sealing operation) of a sealant which seals a gap between components in various structures, training of a sealing operation using a simulated sealant which is a composition assuming a sealant has been performed. For example, the silicone composition described in PTL 1 can be used as the simulated sealant.

### CITATION LIST

### Patent Literature

[PTL 1] Japanese Unexamined Patent Application Publication No. 62-34955

### SUMMARY OF INVENTION

### Technical Problem

However, the silicone composition described in PTL 1 has a problem in that viscosity close to that of the actual sealant cannot be obtained.

The present invention provides a simulated sealant in which it is possible to obtain viscosity close to that of the actual sealant.

### Solution to Problem

In order to solve the above problem, the present invention adopts the following means.

That is, according to an aspect of the present invention, there is provided a simulated sealant containing a polybutene resin and a polyethylene resin, in which the polyethylene resin is in a sol state and is diffused in the polybutene resin.

According to this configuration, the polyethylene resin as a thickener is diffused in a sol state in polybutene as base oil, whereby the viscosity of the simulated sealant can be adjusted. In this way, the simulated sealant can obtain viscosity close to that of the actual sealant.

Further, in the above simulated sealant, the content of the polyethylene resin may be 4% by mass or more and 9% by mass or less.

According to this configuration, the content of the polyethylene resin in the simulated sealant is 4% by mass or more and 9% by mass or less, and therefore, it is possible to adjust the simulated sealant to suitable viscosity.

Further, in the above simulated sealant, the content of the polyethylene resin may be 6% by mass or more and 7% by mass or less.

According to this configuration, the content of the polyethylene resin in the simulated sealant is 6% by mass or more and 7% by mass or less, and therefore, it is possible to adjust the simulated sealant to more suitable viscosity.

Further, in the above simulated sealant, a colorant of less than 5% by mass may be contained as an additive.

According to this configuration, slight coloring having the content of 5% by mass or less is performed on the transparent simulated sealant containing polybutene and the polyethylene resin, whereby it is possible to secure the visibility of the surface shape of the simulated sealant. Further, it is possible to suppress the deterioration of the visibility of internal air bubbles of the simulated sealant due to the coloring.

Further, according to another aspect of the present invention, there is provided a test piece for sealing operation training including: a base member; and a core member which is detachably disposed on an upper surface of the base member, in which the simulated sealant according to the above aspect is applied to a joining portion between the base member and the core member and grid-like ruled lines are provided at equal intervals on the upper surface of the base member.

According to this configuration, the grid-like ruled lines are provided at equal intervals on the upper surface of the base member to which the transparent simulated sealant is applied, and therefore, when performing sealing operation training using the test piece for sealing operation training, by visually observing the ruled lines, it is possible to immediately grasp the length or thickness of the applied simulated sealant. In this way, it is possible to improve the speed or accuracy of the sealing operation and to enhance the learning level of the sealing operation in a short period of time.

Further, by using the transparent simulated sealant, it becomes possible to visually recognize the ruled lines on the upper surface of the base member through the simulated sealant. Accordingly, it is possible to secure the visibility of the ruled lines.

Further, in the above test piece for sealing operation training, a height reference line indicating a size in an up-down direction of the applied simulated sealant may be provided on a side surface of the core member.

According to this configuration, the height reference line is provided on the side surface of the core member, and therefore, the size in the up-down direction of the simulated sealant applied to the side surface can be immediately grasped by visually observing the height reference line. In this way, it is possible to improve the accuracy of the sealing operation and to enhance the learning level in a shorter period of time.

### Advantageous Effects of Invention

According to the simulated sealant of the present invention, it is possible to obtain viscosity close to that of the actual sealant.

### BRIEF DESCRIPTION OF DRAWINGS

FIG. 1 is a perspective view showing a test piece for sealing operation training according to an embodiment of the present invention.

FIG. 2 is a perspective view showing Modification Example 1 of the test piece for sealing operation training shown in FIG. 1.

FIG. 3 is a perspective view showing Modification Example 2 of the test piece for sealing operation training shown in FIG. 1.

FIG. 4A is a perspective view showing a base member in Modification Example 3 of the test piece for sealing operation training shown in FIG. 1.

FIG. 4B is a perspective view showing a core member in an aspect of Modification Example 3 of the test piece for sealing operation training shown in FIG. 1.

FIG. 4C is a perspective view showing a core member in another aspect of Modification Example 3 of the test piece for sealing operation training shown in FIG. 1.

FIG. 5A is a perspective view showing a core member in an aspect of Modification Example 4 of the test piece for sealing operation training shown in FIG. 1.

FIG. 5B is a perspective view showing a core member in another aspect of Modification Example 4 of the test piece for sealing operation training shown in FIG. 1.

FIG. 6A is a perspective view showing a state where an auxiliary piece is mounted to a core member in Modification Example 5 of the test piece for the sealing operation training shown in FIG. 1.

FIG. 6B is a perspective view showing a modification example of the auxiliary piece.

FIG. 6C is a perspective view showing another modification example of the auxiliary piece.

### DESCRIPTION OF EMBODIMENTS

Hereinafter, an embodiment of the present invention will be described with reference to the drawings.

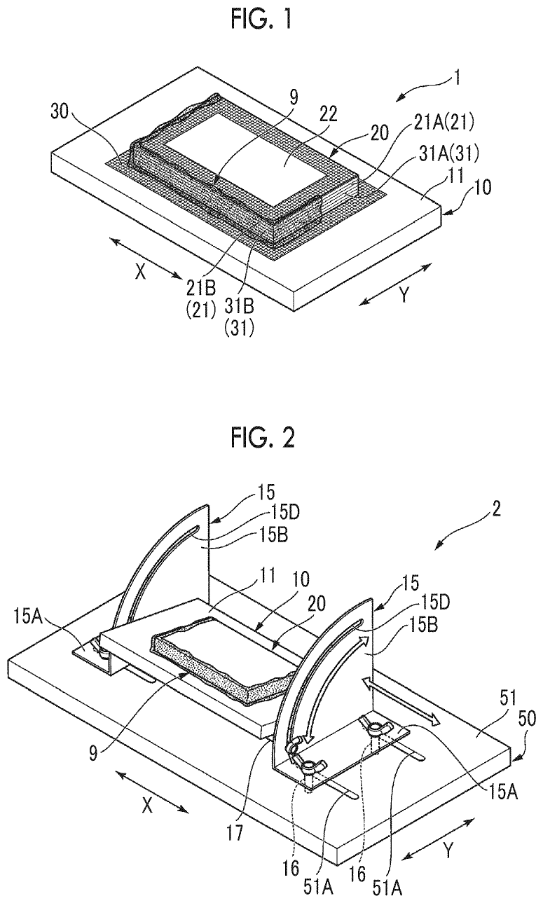

A simulated sealant 9 (refer to FIG. 1) according to an embodiment of the present invention is a composition compounded to simulate a sealant. The simulated sealant 9 is mainly used for training for the purpose of improving a learning level in a sealant application operation (a sealing operation) for sealing a gap between components in a structure.

The simulated sealant 9 is required to have visibility of air bubbles which are formed in the interior thereof and viscosity equivalent to that of a sealant. Describing in detail this point, common sealants are often black and opaque sealants, and it is difficult to visually recognize internal air bubbles after application to a sealing portion. In sealing operation training, there is a step of removing the internal air bubbles while molding the simulated sealant 9 after application to the sealing portion with a molding tool such as a spatula, and therefore, it is preferable that the internal air bubbles can be visually recognized in the simulated sealant 9.

Further, the viscosity of the simulated sealant 9 mainly affects a feeling (softness) when applying the simulated sealant 9, a maintainability of a shape after application, a followability (stringiness) to a spatula or the like at the time of molding with the spatula or the like after application, or the like.

The simulated sealant 9 contains a polybutene resin and a polyethylene resin. The polyethylene resin is in a sol state and is diffused in polybutene. The content of the polyethylene resin is preferably 4% by mass or more and 9% by mass or less (hereinafter, % by mass will be omitted unless otherwise stated). Further, the content of the polyethylene resin is more preferably 6% or more and 7% or less.

The simulated sealant 9 is transparent, and in the example shown, it has a light vermilion color. The simulated sealant 9 may be colorless. In a case where the simulated sealant 9 is colored, it is preferable that it contain a colorant of less than 5% as an additive. The simulated sealant 9 is colored and transparent, whereby the outer shape of the simulated sealant 9 can be easily visually recognized and the visibility of the internal air bubbles (described later) can be secured.

The simulated sealant 9 has recyclability. That is, after application of the simulated sealant 9, the simulated sealant 9 can be reused by performing degassing and vacuuming. In this respect, unlike a sealant which solidifies after application, the cost can be reduced by repeatedly reusing the simulated sealant 9.

Next, as shown in FIG. 1, a test piece for sealing operation training 1 according to an embodiment of the present invention includes a base member 10 and a core member 20 which is detachably disposed on an upper surface 11 of the base member 10. Each of the base member 10 and the core member 20 is a rectangular plate-like member in which the front and back surfaces thereof face in an up-down direction and which is long in one direction of horizontal directions orthogonal to the up-down direction when viewed in a top view.

In the following description, the one direction is referred to as a right-left direction X, and a direction orthogonal to the right-left direction X among the horizontal directions is referred to as a front-rear direction Y. Further, in the right-left direction X and the front-rear direction Y, a direction toward the central portion in the horizontal direction of the base member 10 is referred to as an inner side, and a direction away from the central portion is referred to as an outer side.

The core member 20 is made smaller than the base member 10 in both the front-rear direction Y and the right-left direction X. The core member 20 is disposed at the central portion in the horizontal direction of the upper surface 11 of the base member 10. The sizes (thicknesses) in the up-down direction of the base member 10 and the core member 20 are equal to each other.

The simulated sealant 9 described above is applied to a joining portion (hereinafter referred to as a sealing portion) between the base member 10 and the core member 20. The simulated sealant 9 is applied to exhibit an aspect of a weld bead in fillet welding across the upper surface 11 of the base member 10 and a side surface 21 intersecting the upper surface 11 of the base member 10, of the outer surfaces of the core member 20. The simulated sealant 9 is applied to the sealing portion between the base member 10 and the core member 20 and then molded while removing internal air bubbles formed in the vicinity of the surface by using a spatula or the like.

Then, in this embodiment, grid-like ruled lines 30 are provided at equal intervals on the upper surface 11 of the base member 10. The ruled lines 30 extend in the front-rear direction Y and the right-left direction X.

The ruled lines 30 are provided at least at a portion which is located on the outer side in the horizontal direction of the core member 20 when viewed in a top view, at the central portion of the upper surface 11 of the base member 10. The ruled lines 30 are marking lines scribed on the upper surface 11 of the base member 10 by using a scriber or the like. In the example shown, the ruled lines 30 are also provided at equal intervals on an upper surface 22 of the core member 20.

The ruled lines 30 can be provided in the range of 10 mm (0.4 inches) from an outer peripheral edge portion of the core member 20 toward the outer side in the horizontal direction when viewed in a top view, for example, at intervals of 1 mm (0.04 inches) in the right-left direction X and the front-rear direction Y.

The ruled lines 30 may also be provided at a portion which is in contact with the lower surface of the core member 20, of the upper surface 11 of the base member 10, or may also be provided on the entire upper surface 11 of the base member 10.

Then, when applying the simulated sealant 9 to the sealing portion between the base member 10 and the core member 20, by simultaneously visually observing the ruled lines 30 and the simulated sealant 9, it is possible to immediately grasp a length dimension (application rate) in which the simulated sealant 9 is applied within an application time, or a width dimension orthogonal to the length dimension of the simulated sealant 9 when viewed in a top view.

Further, in this embodiment, a height reference line 31 indicating the thickness of the applied simulated sealant 9 is provided on the side surface 21 of the core member 20. The height reference line 31 extends parallel to the outer peripheral edge portion of the core member 20 when viewed in a top view.

A first height reference line 31A provided on each of first side surfaces 21A facing both outer sides in the right-left direction X, of the side surfaces 21 of the core member 20, extends in the front-rear direction Y. Further, a second height reference line 31B provided on each of second side surfaces 21B facing both outer sides in the front-rear direction Y, of the side surfaces 21 of the core member 20, extends in the right-left direction X.

The height reference lines 31 are provided at intervals equal to the intervals of the ruled lines 30 in the up-down direction over the entire area in the up-down direction of the side surface 21 of the core member 20. The height reference lines 31 are marking lines scribed on the side surface 21 of the core member 20 by using a scriber or the like. The height reference lines 31 may be provided at intervals different from the intervals of the ruled lines 30.

When applying the simulated sealant 9 to the sealing portion between the base member 10 and the core member 20, by simultaneously visually observing the height reference line 31 and the simulated sealant 9, it is possible to immediately grasp a length dimension of the simulated sealant 9. The height reference line 31 may be formed at only a part of the side surface 21 of the core member 20. Further, a length reference line orthogonal to the height reference line 31 may also be provided on the side surface 21 of the core member 20.

### Modification Example 1

Next, the respective modification examples of the embodiment described above will be described. In each of the following modification examples, unless otherwise stated, the illustration of the ruled lines 30 and the height reference lines 31 is omitted.

A test piece for sealing operation training 2 according to Modification Example 1 will be described using FIG. 2. Further, in the following description, the same configurations as those in the contents described above are denoted by the same reference numerals and detailed description thereof is omitted.

As shown in FIG. 2, in the test piece for sealing operation training 2, the base member 10 is disposed on an adjustment stand 50 provided with an adjustment plate 15. The adjustment stand 50 is a rectangular plate-like member in which the front and back surfaces thereof face in the up-down direction and which is long in the right-left direction when viewed in a top view.

A pair of adjustment plates 15 is disposed at an interval in the right-left direction X on an upper surface 51 of the adjustment stand 50. The pair of adjustment plates 15 is separately disposed at portions of the upper surface 51 of the adjustment base 50, which are located on both outer sides in the right-left direction X of the base member 10.

The adjustment plate 15 includes a fixing portion 15A in which the front and back surfaces thereof face in the up-down direction and which has a rectangular shape when viewed in a top view and, an angle adjustment portion 15B in which the front and back surfaces thereof face in the right-left direction X and which is connected to an inner end portion in the right-left direction X of the fixing portion 15A.

A pair of fixing holes (not shown) penetrating the fixing portion 15A in the up-down direction is formed at an interval in the front-rear direction Y In the fixing portion 15A.

The angle adjustment portion 15B has a fan shape spread upward on one side in the front-rear direction Y when viewed in a side view as viewed from the right-left direction X. A circular arc-shaped angle adjustment groove 15D which penetrates the angle adjustment portion 15B in the right-left direction X and extends along a circular arc portion of the angle adjustment portion 15B is formed in the angle adjustment portion 15B. The angle adjustment groove 15D is formed over the entire circumference except for peripheral end portions of the circular arc portion of the angle adjustment portion 15B.

A pair of width adjustment grooves 51A depressed downward and extending in the right-left direction X is formed at an interval in the front-rear direction Y on the upper surface 51 of the adjustment stand 50. Two pairs of width adjustment grooves 51A are formed at portions of the upper surface 51 of the adjustment stand 50, which are located on both outer sides in the right-left direction X of the base member 10.

A fixing screw 16 is inserted into the width adjustment groove 51A through a fixing hole of the fixing portion 15A and is detachably fixed by a butterfly nut or the like. The distance in the right-left direction X between the pair of adjustment plates 15 can be randomly adjusted by loosening the fixing screw 16 and moving the adjustment plate 15 together with the fixing screw 16 in the right-left direction X.

An adjustment screw 17 protruding outward in the right-left direction X is disposed on the lower surface of the base member 10. The adjustment screw 17 is separately disposed at an end portion on one side in the front-rear direction Y of the lower surface of the base member 10.

The adjustment screw 17 is separately inserted into the angle adjustment groove 15D of the angle adjustment portion 15B of the adjustment plate 15 and is fixed by a butterfly nut or the like. The base member 10 is supported on the angle adjustment portion 15B so as to be rotatable with an end portion on the other side in the front-rear direction Y as a rotation center. For this reason, the angle of the upper surface 11 of the base member 10 can be adjusted by loosening the butterfly nut and moving the adjustment screw 17 in the angle adjustment groove 15D along the angle adjustment groove 15D.

In this manner, by adjusting the distance in the right-left directions X between the pair of adjustment plates 15 and the angle of the upper surface 11 of the base member 10, it is possible to perform training of a wide range of sealing operations assuming various situations such as, for example, a situation in which a work space for applying a sealant is narrow, or a situation in which a sealing portion to which a sealant is applied is inclined.

### Modification Example 2

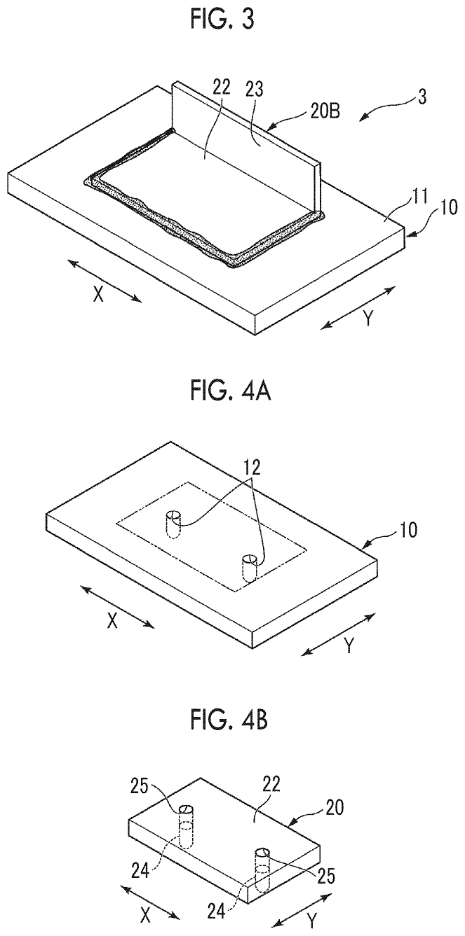

Next, a test piece for sealing operation training 3 according to Modification Example 2 will be described using FIG. 3. In the following description, the same configurations as those in the contents described above are denoted by the same reference numerals and detailed description thereof is omitted.

As shown in FIG. 3, a core member 20B of the test piece for sealing operation training 3 has an L-shape when viewed in a side view as viewed from the right-left direction X. An upright wall 23 extending upward is formed at an end portion on the other side in the front-rear direction Y of the core member 20B. The thickness dimension of the core member 20B and the thickness dimension in the front-rear direction Y of the upright wall 23 are the same over the entire area of the core member 20B. The thickness dimension of the core member 20B is made smaller than the thickness dimension of the base member 10.

### Modification Example 3

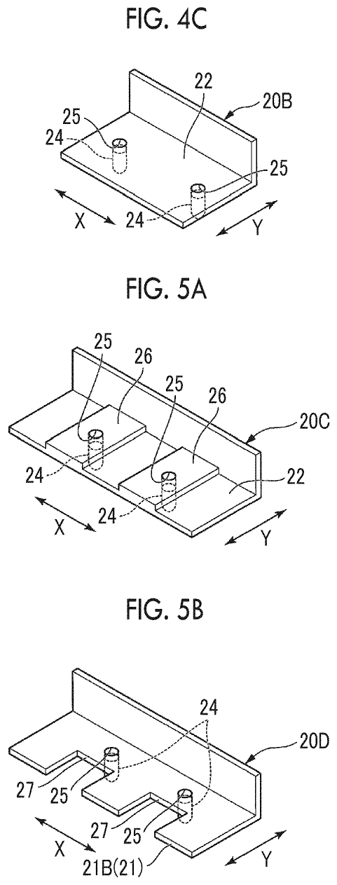

Next, a test piece for sealing operation training according to Modification Example 3 will be described using FIGS. 4A to 4C. In the following description, the same configurations as those in the contents described above are denoted by the same reference numerals and detailed description thereof is omitted.

As shown in FIG. 4A, a positioning hole 12 which is depressed downward is formed on the upper surface 11 of the base member 10 of the test piece for sealing operation training. A pair of positioning holes 12 is formed at an interval in the right-left direction X. The positioning holes 12 are formed at the central portion in the horizontal direction of the upper surface 11 of the base member 10.

The positioning holes 12 are disposed inside a portion as shown by a two-dot chain line in FIG. 4A, where the outer peripheral edge portion of the core member 20 when viewed in a top view is located, of the upper surface 11 of the base member 10.

As shown in FIGS. 4B and 4C, a positioning protrusion 24 protruding downward is formed on the lower surface of each of the core members 20 and 20B in the test piece for sealing operation training. A pair of positioning protrusions 24 is formed at an interval in the right-left direction X. The positioning protrusions 24 are formed at the central portion in the front-rear direction Y of the lower surface of the core member 20. A mounting hole 25 depressed downward is separately formed at the position equivalent to the position of the positioning protrusion 24 when viewed in a top view, of the upper surface 22 of each of the core members 20 and 20B.

Each of the core members 20 and 20B is disposed on the upper surface 11 of the base member 10 in a state where the pair of positioning protrusions 24 is separately inserted into the pair of positioning holes 12 of the base member 10. For this reason, when applying the simulated sealant 9 to the sealing portion between the base member 10 and the core member 20, the core member 20 can be suppressed from being displaced with respect to the base member 10.

The number of positioning holes 12 and the number of positioning protrusions 24 may be one or may be three or more.

### Modification Example 4

Next, a test piece for sealing operation training according to Modification Example 4 will be described using FIGS. 5A and 5B. In the following description, the same configurations as those in the contents described above are denoted by the same reference numerals and detailed description thereof is omitted.

As shown in FIGS. 5A and 5B, core members 20C and 20D of the test piece for sealing operation training have various shapes. As shown in FIG. 5A, the core member 20C has a substantially L-shape when viewed in a side view as viewed from the right-left direction X. A plurality of protrusion portions 26 which protrude upward are formed at intervals in the right-left direction X on the upper surface 22 of the core member 20C. The size in the right-left direction X of the protrusion portion 26 is made equal to the distance between the protrusion portions 26 adjacent to each other.

As shown in FIG. 5B, a cutout recess portion 27 depressed toward the other side in the front-rear direction Y and having a rectangular shape when viewed in a top view is formed in the second side surface 21B which is located on one side in the front-rear direction Y of the core member 20D. A plurality of cutout recess portions 27 are formed at intervals in the right-left direction X. The size in the right-left direction X of the cutout recess portion 27 is made equal to the distance between the cutout recess portions 27 adjacent to each other.

The plurality of cutout recess portions 27 are formed in the core member 20D, whereby the circumferential length of an outer peripheral edge portion of the sealing portion between the base member 10 and the core member 20D becomes long and the shape of the sealing portion becomes complicated, so that the learning level required for the sealing operation can be adjusted.

In this manner, by using the base member 10 in common and making the core members 20C and 20D having various shapes exchangeable, it is possible to perform training at an appropriate level in accordance with workers of various levels.

### Modification Example 5

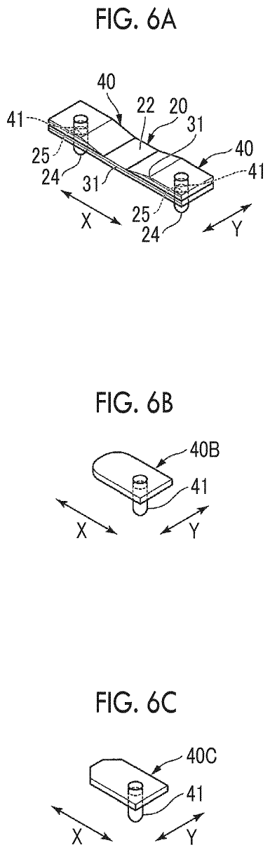

Next, a test piece for sealing operation training according to Modification Example 5 will be described using FIGS. 6A to 6C. In the following description, the same configurations as those in the contents described above are denoted by the same reference numerals and detailed description thereof is omitted.

As shown in FIGS. 6A to 6C, a plurality of auxiliary pieces 40 are assembled to the upper surface 22 of the core member 20 of the test piece for sealing operation training.

In the core member 20 shown in FIG. 6A, the plurality of auxiliary pieces 40 are disposed on the upper surface 22. A mounting protrusion 41 protruding downward is formed on the lower surface of the auxiliary piece 40. The mounting protrusion 41 is inserted into the mounting hole 25 of the upper surface 22 of the core member 20, whereby the auxiliary piece 40 is assembled to the core member 20.

The sizes in the front-rear direction Y of the core member 20 and the auxiliary piece 40 are equal to each other. The auxiliary piece 40 may be smaller than the core member 20 in the front-rear direction Y.

The auxiliary piece 40 has a rectangular shape when viewed in a top view. An end portion on the inner side in the right-left direction X of the upper surface of the auxiliary piece 40 is formed in an inclined surface shape extending downward toward the inner side in the right-left direction X. Further, the height reference lines 31 are provided on the side surface of the auxiliary piece 40.

An auxiliary piece 40B shown in FIG. 6B has the same thickness over the entire area in the right-left direction X. In the auxiliary piece 40B, an end portion on the inner side in the right-left direction X is formed in a curved surface shape which protrudes inward in the right-left direction X. Instead of the configuration formed in a curved surface shape in this manner, as in an auxiliary piece 40C shown in FIG. 6C, a configuration may be adopted in which corner portions located on both outer sides in the front-rear direction Y of the end portion on the inner side in the right-left direction X are chamfered in a planar shape.

### Example

Examples of the simulated sealant 9 according to the present invention are shown below together with a comparative example. The examples shown below are merely examples of the present invention, and the present invention is not limited to the examples described below.

As shown in Table 1, simulated sealants A1 to A10 as examples were produced by mixing polybutene and a polyethylene resin. Further, a simulated sealant B1 as a comparative example was produced by mixing a polybutylene resin and silica.

In the production of Examples A1 to A10, polymeric polybutylene (molecular weight: 1350, viscosity at 40° C.: 24000 [mm²/s]) was used as polybutene that is base oil. A polyethylene resin which is a thickener was dissolved by heating from a state being a pellet shape having a diameter of several mm and mixed with the polymeric polybutylene in a re-solidified state. In this way, the polyethylene resin is in a sol state and is diffused in polybutene.

In the production of Comparative Example B1, low polybutene (molecular weight: 720, viscosity at 40° C.: 2100 [mm²/s]) was used as polybutene. Silica which is a thickener was mixed with the low polybutene in a state having a diameter in a range of 5 to 50 nm.

TABLE 1

| | A1 | A2 | A3 | A4 | A5 | A6 |
|---|---|---|---|---|---|---|
| Base oil | High polybutene | | | | | |
| [% by weight] | Remainder | | | | | |
| Thickener | Polyethylene resin | | | | | |
| [% by weight] | 1 | 3.5 | 4 | 5 | 6 | 7 |
| Supplied | — | | | | Red | — |
| coloring material | | | | | 6 | |
| [% by weight] | | | | | | |
| Application- | Flow | Dripping | Soft, No | Soft, No | Soft, No | Soft, No |
| spatula | | | dripping, | dripping, | dripping, | dripping, |
| moldability | | | Transparence | Transparence | Transparence | Transparence |
| Visualization | — | — | A | A | A | A |
| visibility | | | | | | |
| Stringiness | — | — | A | A | A | A |

| | A7 | A8 | A9 | A10 | B1 |
|---|---|---|---|---|---|
| Base oil | High polybutene | | | | Low |
| | | | | | polybutene |
| [% by weight] | Remainder | | | | Remainder |
| Thickener | Polyethylene resin | | | | Silica |
| [% by weight] | 8 | 9 | 10 | 15 | 5 |
| Supplied | — | | | | — |
| coloring material | | | | | |
| [% by weight] | | | | | |
| Application- | No dripping, | No dripping, | No dripping, | Hard, | — |
| spatula | Hard, | Hard, | Hard, | Application | (viscosity |
| moldability | Application | Application | Application | and spatula | is low) |
| | and spatula | and spatula | and spatula | molding are | |
| | molding are | molding are | molding are | difficult | |
| | possible | possible | possible | | |
| Visualization | A | A | C | C | — |
| visibility | | | | | |
| Stringiness | B | B | B | C | — |

Next, the determination results as simulated sealants for Examples A1 to A10 obtained in this way will be described. In all Examples A1 to A10, it was confirmed that adjustment of viscosity to viscosity capable of being applied to the sealing portion could be made by adjusting viscosity by adding a polyethylene resin which is a thickener to polybutene which is base oil.

Describing in detail each of Examples A1 to A10, in A1, it was confirmed that when the simulated sealant was applied, the simulated sealant flowed from a sealing surface. In A2, it was confirmed that after the simulated sealant was applied, the simulated sealant dripped from a sealing surface with the passage of time.

In A3 and A4, it was confirmed that the simulated sealants were soft, did not drip after application, and were transparent. The stringiness was also good. That is, it was confirmed that the simulated sealants had suitable viscosity and visibility as a simulated sealant.

However, it was confirmed that in application to an upward work surface in a high temperature environment such as the summer season, there is a concern that the simulated sealant after the application may drip during prolonged work.

In A5 and A6, it was confirmed that the simulated sealants were soft, did not drip after application, and were transparent. The stringiness was also good. That is, it was confirmed that the simulated sealants had more suitable viscosity and visibility as a simulated sealant.

In A7 and A8, it was confirmed that the simulated sealants were hard within the range where application is possible and molding with a spatula is possible, the simulated sealants did not drip after application, and internal air bubbles were visible. The stringiness was sufficient. That is, it was confirmed that the simulated sealants had preferable viscosity and visibility as a simulated sealant.

In A9, it was confirmed that although the simulated sealant was hard within the range where application is possible and molding with a spatula is possible, and although the simulated sealants did not drip after application, the visibility of internal air bubbles was not good. The stringiness was sufficient.

In A10, it was confirmed that the simulated sealant was hard to the extent that application and molding with a spatula are difficult, and internal air bubbles were not visible due to being opaque.

Next, the determination results for Comparative Example B1 will be demonstrated.

In B1 in which silica as a thickener was mixed, it was confirmed that in heat treatment in a manufacturing process, thermal decomposition, hydrolysis, and the like occurred and a Si—O bond of silica was broken to lower viscosity, and therefore, the simulated sealant could not be applied to a sealing portion in a state of maintaining a shape.

As described above, according to the simulated sealant 9 of this embodiment, the polyethylene resin as a thickener is diffused in a sol state in polybutene as base oil, whereby the viscosity of the simulated sealant 9 can be adjusted. In this way, the simulated sealant 9 can obtain viscosity close to that of the actual sealant.

Further, in a case where the content of the polyethylene resin in the simulated sealant 9 is 4% or more and 9% or less, it is possible to adjust the simulated sealant 9 to suitable viscosity.

Further, in a case where the content of the polyethylene resin in the simulated sealant 9 is 6% or more and 7% or less, it is possible to adjust the simulated sealant 9 to more suitable viscosity.

Further, slight coloring having the content of 5% by mass or less is performed on the transparent simulated sealant 9 containing polybutene and the polyethylene resin, whereby it is possible to secure the visibility of the surface shape of the simulated sealant 9 and to suppress the deterioration of the visibility of the internal air bubbles of the simulated sealant 9 due to the coloring.

Further, in the test piece for sealing operation training 1, the grid-like ruled lines 30 are provided at equal intervals on the upper surface 11 of the base member 10 to which the transparent simulated sealant 9 is applied. For this reason, when performing sealing operation training using the test piece for sealing operation training 1, by visually observing the ruled lines 30, it is possible to immediately grasp the length or thickness of the applied simulated sealant 9. In this way, it is possible to improve the speed or accuracy of the sealing operation and to enhance the learning level of the sealing operation in a short period of time.

Further, by using the transparent simulated sealant 9, it becomes possible to visually recognize the ruled lines 30 on the upper surface 11 of the base member 10 through the simulated sealant 9, and thus it is possible to secure the visibility of the ruled lines 30.

Further, the height reference lines 31 are provided on the side surface 21 of the core member 20 in the test piece for sealing operation training 1. For this reason, the thickness of the simulated sealant 9 applied to the side surface 21 can be immediately grasped by visually observing the height reference line 31. In this way, it is possible to improve the accuracy of the sealing operation and to enhance the learning level in a shorter period of time.

The embodiment of the present invention has been described in detail above with reference to the drawings. However, the specific configuration is not limited to this embodiment, and design changes and the like within a scope which does not depart from the gist of the present invention are also included.

For example, in the embodiment described above, the configuration has been described in which the content of the polyethylene resin is preferably 4% or more and 9% or less and more preferably 6% or more and 7% or less. However, there is no limitation to such a range. The content of the polyethylene resin may be less than 4% or may be more than 9%.

Further, in the embodiment described above, the configuration has been described in which polybutene is used as base oil. However, there is no limitation to such an aspect. From the viewpoint of securing transparency, there is no limitation to polybutene. As the base oil, an epoxy resin, an acrylic resin, an olefin-based polymer, or an oil-soluble polymer may be used. Among these, polyisobutylene, olefin copolymer, polymetallate, and the like are particularly preferable.

Further, in the embodiment described above, the configuration has been described in which the polyethylene resin is used as a thickener. However, there is no limitation to such an aspect. From the viewpoint of adjusting the viscosity, there is no limitation to the polyethylene resin. As the thickener, a synthetic resin material such as polycarbonate, polypropylene, polyvinylene chloride, polyvinylidene fluoride, polyethylene terephthalate, or polybutylene terephthalate may be adopted, or a material such as graphite, mica, talc, calcium carbonate, or titanium oxide may be adopted.

Further, in the embodiment described above, the configuration has been described in which the height reference lines 31 are provided on the side surface 21 of the core member 20 in the test piece for sealing operation training 1. However, there is no limitation to such an aspect. The height reference line 31 may not be provided on the side surface 21 of the core member 20.

### INDUSTRIAL APPLICABILITY

According to the simulated sealant described above, it is possible to obtain viscosity close to that of the actual sealant.

### REFERENCE SIGNS LIST

1, 2, 3: test piece for sealing operation training
10: base member
20, 20B, 20C, 20D: core member
21: side surface
30: ruled line
31: height reference line

1. A simulated sealant comprising:
a polybutene resin; and
a polyethylene resin,
wherein the polyethylene resin is in a sol state and is diffused in the polybutene resin.

2. The simulated sealant according to claim 1, wherein a content of the polyethylene resin is 4% by mass or more and 9% by mass or less.

3. The simulated sealant according to claim 1, wherein a content of the polyethylene resin is 6% by mass or more and 7% by mass or less.

4. The simulated sealant according to claim 1, wherein a colorant of less than 5% by mass is contained as an additive.

5. A test piece for sealing operation training comprising:
a base member; and
a core member which is detachably disposed on an upper surface of the base member,
wherein the simulated sealant according to claim 1 is applied to a joining portion between the base member and the core member, and
grid-like ruled lines are provided at equal intervals on the upper surface of the base member.

6. The test piece for sealing operation training according to claim 5, wherein a height reference line indicating a size in an up-down direction of the applied simulated sealant is provided on a side surface of the core member.
